(19) United States
(12) Patent Application Publication
(10) Pub. No.: US 2025/0382020 A1
(43) Pub. Date: Dec. 18, 2025

(54) Tractor Cab Assembly

(71) Applicant: Jessica Washington, Clarksville, TN (US)

(72) Inventor: Jessica Washington, Clarksville, TN (US)

(21) Appl. No.: 18/741,499

(22) Filed: Jun. 12, 2024

(51) Int. Cl. B62D 33/06; B60H 1/00; B60K 16/00; B60Q 1/04; B60Q 1/22; B60R 1/06; B60R 25/23

(52) U.S. Cl. CPC B62D 33/0617; B60H 1/00378; B60K 16/00; B60Q 1/04; B60Q 1/22; B60R 1/06; B60R 25/23; B60K 2016/003

(57) ABSTRACT

A tractor cab assembly for protecting a mower driver from sunlight includes a cab that is positionable on a tractor having the cab completely surrounding a driver's seat of the tractor. The cab has a plurality of windows integrated therein. Each of the windows is comprised of an ultraviolet blocking material to protect a driver of the tractor from ultraviolet radiation from the sun. An air conditioning unit is coupled to the cab. The air conditioning unit blows air into the cab when the air conditioning unit is turned on. Additionally, the air conditioning unit cools the blown air when the air conditioning unit is turned on for cooling the driver.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention.

The disclosure relates to cab devices and more particularly pertains to a new cab device for protecting a mower driver from sunlight.

### (2) Description of Related Art including information disclosed under 37 CFR 1.97 and 1.98

The prior art relates to cab devices.

### (h) BRIEF SUMMARY OF THE INVENTION

An embodiment of the disclosure meets the needs presented above by generally comprising a cab that is positionable on a tractor having the cab completely surrounding a driver's seat of the tractor. The cab has a plurality of windows integrated therein. Each of the windows is comprised of an ultraviolet blocking material to protect a driver of the tractor from ultraviolet radiation from the sun. An air conditioning unit is coupled to the cab. The air conditioning unit blows air into the cab when the air conditioning unit is turned on. Additionally, the air conditioning unit cools the blown air when the air conditioning unit is turned on for cooling the driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tractor cab assembly according to an embodiment of the disclosure.

FIG. 2 is a front view of an embodiment of the disclosure.

FIG. 3 is a left side view of an embodiment of the disclosure.

FIG. 4 is a back view of an embodiment of the disclosure.

FIG. 5 is a top view of an embodiment of the disclosure.

FIG. 6 is a perspective view of a control panel of an embodiment of the disclosure.

FIG. 7 is a schematic view of an embodiment of the disclosure.

### (j) DETAILED DESCRIPTION OF THE INVENTION

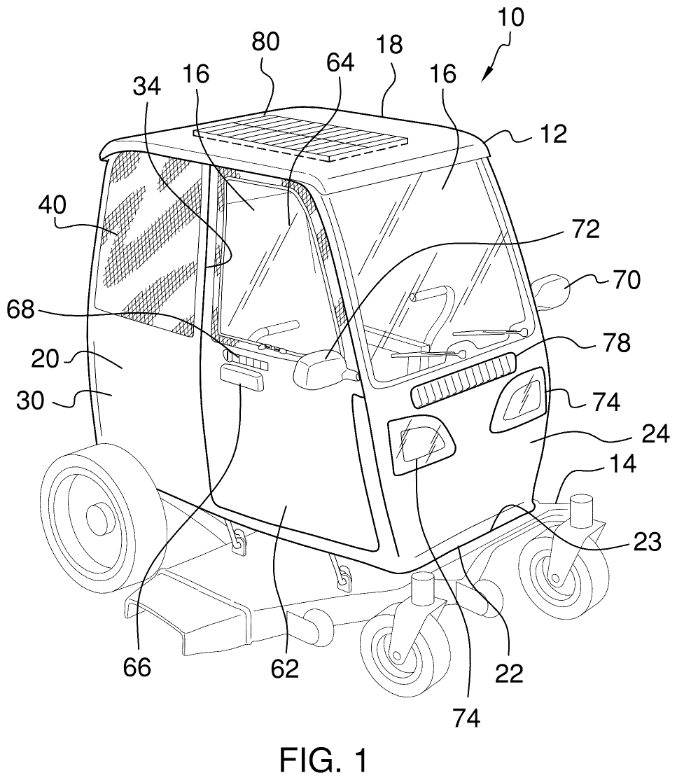

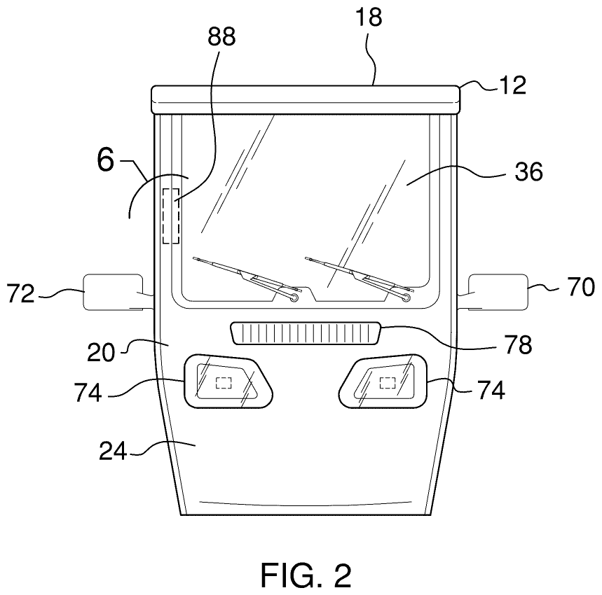

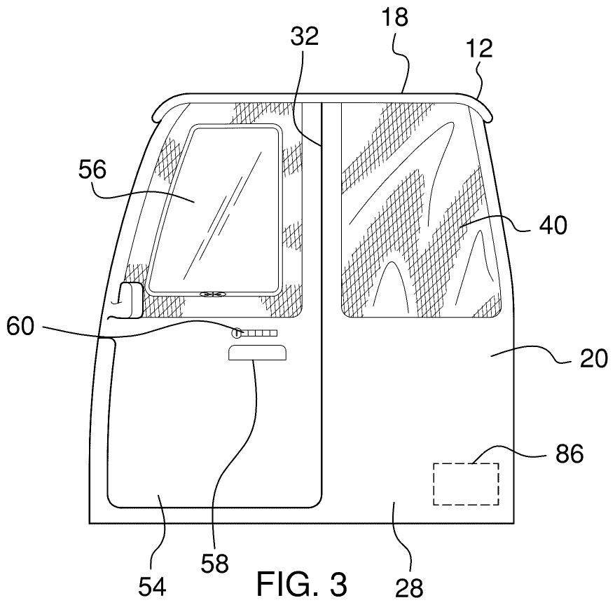

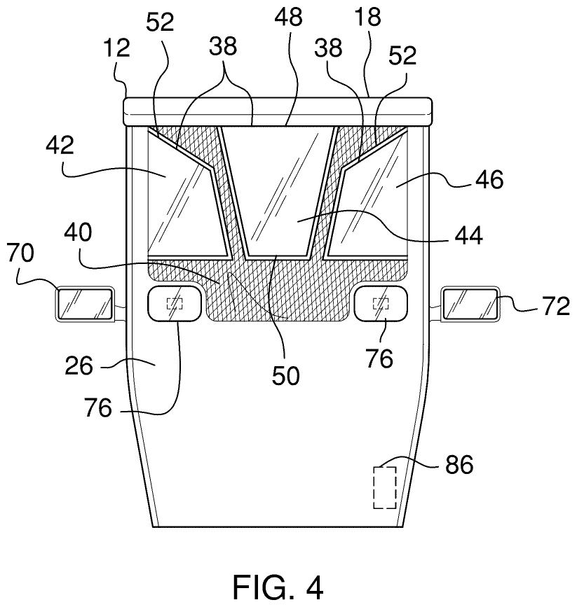

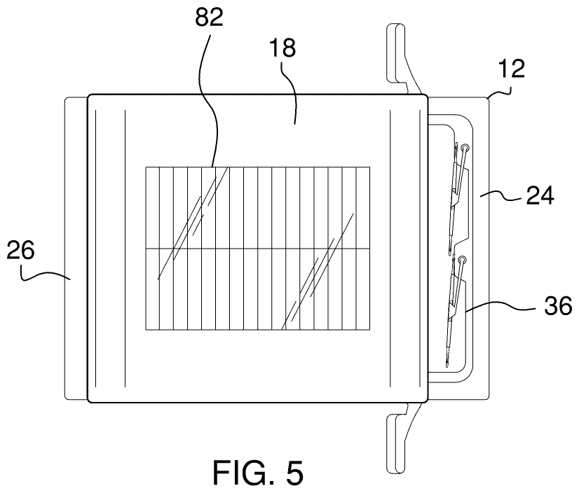

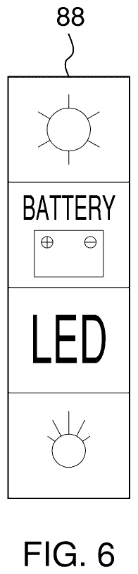

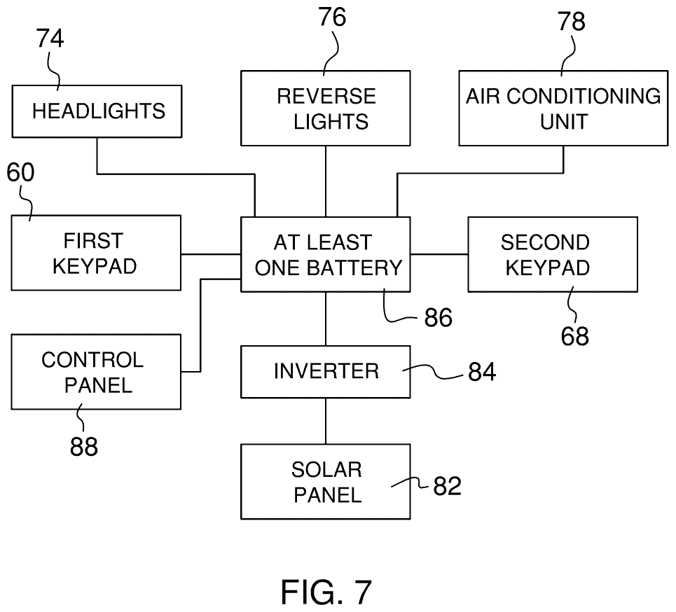

With reference now to the drawings, and in particular to FIGS. 1 through 7 thereof, a new cab device embodying the principles and concepts of an embodiment of the disclosure and generally designated by the reference numeral 10 will be described.

As best illustrated in FIGS. 1 through 7, the tractor cab assembly 10 generally comprises a cab 12 is positionable on a tractor 14 having the cab 12 completely surround a driver's seat of the tractor 14. The tractor 14 may be a riding lawn mower of any conventional design, including zero turn mowers with lever steering and mowers with steering wheel steering. The cab 12 has a plurality of windows 16 integrated into the cab 12. Each of the windows 16 is comprised of an ultraviolet blocking material to protect a driver of the tractor 14 from ultraviolet radiation from the sun. The cab 12 may be manufactured in a variety of dimensions for fitment on a variety of makes and models of tractors.

The cab 12 has a top wall 18 and a perimeter wall 20 extending downwardly therefrom, and the perimeter wall 20 has a distal edge 22 with respect to the top wall 18 defining an opening into the cab 12. The distal edge 22 of the perimeter wall 20 rests on a deck 23 of the tractor 14 having the top wall 18 being spaced upwardly from the driver's seat. The perimeter wall 20 has a front side 24, a back side 26, a first lateral side 28 and a second lateral side 30. The first lateral side 28 has a first doorway 32 extending into an interior of the cab 12 to facilitate the driver to enter and exit the cab 12. Additionally, the second lateral side 30 has a second doorway 34 extending into an interior of the cab 12 to facilitate the driver to enter and exit the cab 12.

The plurality of windows 16 includes a windshield 36 and a set of rear windows 38. The windshield 36 is positioned on the front side 24 of the perimeter wall 20 of the cab 12 and each of the rear windows 38 is positioned on the back side 26 of the perimeter wall 20 of the cab 12. Each of the first lateral side 28, the second lateral side 30 and the back side 26 has a mesh portion 40 being integrated therein for ventilating the cab 12. The mesh portion 40 on the first lateral side 28 extends between the first doorway 32 and the back side 26. The mesh portion 40 on the second lateral side 30 extends between the second doorway 34 and the back side 26. The mesh portion 40 on the back side 26 extends between the first lateral side 28 and the second lateral side 30. Additionally, the mesh portion 40 on each of the first lateral side 28, the second lateral side 30 and the back side 26 extends downwardly from the top wall 18 of the cab 12.

Each of the rear windows 38 is positioned on the mesh portion 40 on the back side 26. The set of rear windows 38 includes a left window 42, a middle window 44 and a right window 46. The middle window 44 tapers inwardly between a top edge 48 and a bottom edge 50 of the middle window 44. Thus, the middle window 44 has a trapezoidal shape. A top edge 52 of each of the left window 42 and the right window 44 slopes downwardly toward the middle window 44.

A first door 54 is hingedly coupled to the cab 12 and the first door 54 is aligned with the first doorway 32 for opening and closing the first doorway 32. A first door window 56 extends through the first door 54 and the first door window 56 is comprised of an ultraviolet blocking material. A first door handle 58 is movably coupled to the first door 54 and the first door handle 58 releasably engages the cab 12 for retaining the first door 54 in a closed position. A first keypad 60 is coupled to the first door 54 and the first keypad 60 is electrically coupled to the first door handle 58. The first keypad 60 facilitates the first door handle 58 to be manipulated when a pre-determined code is correctly entered into the first keypad 60.

A second door 62 is hingedly coupled to the cab 12 and the second door 62 is aligned with the second doorway 34 for opening and closing the second doorway 34. A second door window 64 extends through the second door 62 and the second door window 64 is comprised of an ultraviolet blocking material. A second door handle 66 is movably coupled to the second door 62 and the second door handle 66 releasably engages the cab 12 for retaining the second door 62 in a closed position. A second keypad 68 is coupled to the second door 62 and the second keypad 68 is electrically coupled to the second door handle 66. The second keypad 68 facilitates the second door handle 66 to be manipulated when a pre-determined code is correctly entered into the second keypad 68.

A first rear view mirror 70 is coupled to the first lateral side 28 of the perimeter wall 20 of the cab 12. A second rear view mirror 72 is coupled to the second lateral side 30 of the perimeter wall 20 of the cab 12. A pair of headlights 74 is each coupled to the cab 12 for emitting light outwardly therefrom. Each of the headlights 74 is positioned on the front side 24 of the perimeter wall 20 of the cab 12. A pair of reverse lights 76 is each coupled to the cab 12 for emitting light outwardly therefrom. Each of the reverse lights 76 is positioned on the back side 26 of the perimeter wall 20 of the cab 12. Each of the headlights 74 and each of the reverse lights 76 may comprise an LED or other similar electronic light emitter.

An air conditioning unit 78 is provided and the air conditioning unit 78 is coupled to the cab 12. The air conditioning unit 78 blows air into the cab 12 when the air conditioning unit 78 is turned on. Additionally, the air conditioning unit 78 cools the blown air when the air conditioning unit 78 is turned on for cooling the driver. The air conditioning unit 78 may comprise an electric air conditioner with a cooling capacity of approximately 5000.0 BTU.

A power supply 80 is provided and the power supply 80 is coupled to the cab 12. Each of the headlights 74 is electrically coupled to the power supply 80 and each of the reverse lights 76 is electrically coupled to the power supply 80. The first keypad 60 is electrically coupled to the power supply 80 and the second keypad 68 is electrically coupled to the power supply 80. Additionally, the air conditioning unit 78 is electrically coupled to the power supply 80.

The power supply 80 comprises a solar panel 82 that is coupled to the top wall 18 of the cab 12 such that the solar panel 82 is exposed to sunlight. The power supply 80 includes an inverter 84 is coupled to the cab 12 and the inverter 84 is electrically coupled to the solar panel 82 for processing the electrical charge produced by the solar panel 82. The power supply 80 includes at least one battery 86 that is electrically coupled to the inverter 84 such that the solar panel 82 charges the at least one battery 86. The power supply 80 includes a control panel 88 for controlling operational parameters of the headlights 74, the reverse lights 76 and the air conditioning unit 78. The control panel 88 may include knobs, buttons and any other type of electronic control.

In use, the cab 12 is placed on the deck 23 of the tractor 14 thereby facilitating the driver to sit in the cab 12. In this way the driver is protected from ultraviolet radiation while the driver is operating the tractor 14. Additionally, the air conditioning unit 78 helps keep the driver cool during hot days. The first keypad 60 and the second keypad 68 inhibit unauthorized users, such as children, from entering the cab 12 and utilizing the tractor 14. In addition to protecting the driver from ultraviolet radiation, the cab 12 protects the driver from debris while the driver is mowing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tractor cab assembly being configured to protect a driver from sunlight while the tractor is being driven, said assembly comprising:
a cab being positionable on a tractor having said cab completely surround a driver's seat of the tractor, said cab have a plurality of windows being integrated therein, each of said windows being comprised of an ultraviolet blocking material wherein said windows are configured to protect a driver of the tractor from ultraviolet radiation from the sun;
a first rear view mirror being coupled to said first lateral side of said perimeter wall of said cab;
a second rear view mirror being coupled to said second lateral side of said perimeter wall of said cab;
a pair of headlights, each of said headlights being coupled to said cab wherein each of said headlights is configured to emit light outwardly therefrom;
a pair of reverse lights, each of said reverse lights being coupled to said cab wherein each of said reverse lights is configured to emit light outwardly therefrom; and
an air conditioning unit being coupled to said cab, said air conditioning unit blowing air into said cab when said air conditioning unit is turned on, said air conditioning unit cooling the blown air when said air conditioning unit is turned on wherein said air conditioning unit is configured to cool the driver.

2. The assembly according to claim 1, wherein said cab has a top wall and a perimeter wall extending downwardly therefrom, said perimeter wall having a distal edge with respect to said top wall defining an opening into said cab, said distal edge of said perimeter wall resting on a deck of the tractor having said top wall being spaced upwardly from the driver's seat, said outer wall having a front side, a back side, a first lateral side and a second lateral side, said first lateral side having a first doorway extending into an interior of said cab wherein said doorway is configured to facilitate the driver to enter and exit said cab, said second lateral side having a second doorway extending into an interior of said cab wherein said doorway is configured to facilitate the driver to enter and exit said cab.

3. The assembly according to claim 2, wherein said plurality of windows includes a windshield and a set of rear windows, said windshield being positioned on said front side of said perimeter wall of said cab, each of said rear windows being positioned on said back side of said perimeter wall of said cab.

4. The assembly according to claim 3, wherein each of said first lateral side, said second lateral side and said back side has mesh portions being integrated therein wherein said cab is configured to be ventilated, said mesh portion on said first lateral side extending between said first doorway and said back side, said mesh portion on said second lateral side extending between said second doorway and said back side, said mesh portion on said back side extending between said first lateral side and said second lateral side, said mesh portion on each of said first lateral side, said second lateral side and said back side extending downwardly from said top wall of said cab, each of said rear windows being positioned on said mesh portion on said back side.

5. The assembly according to claim 4, wherein said set of rear windows includes a left window, a middle window and a right window, said middle window tapering inwardly between a top edge and a bottom edge of said middle window such that said middle window has a trapezoidal shape, a top edge of each of said left window and said left window sloping downwardly.

6. The assembly according to claim 2, further comprising a first door being hingedly coupled to said cab, said first door being aligned with said first doorway for opening and closing said first doorway.

7. The assembly according to claim 6, further comprising a first door window extending through said first door, said first door window being comprised of an ultraviolet blocking material.

8. The assembly according to claim 7, further comprising:
a first door handle being movably coupled to said first door, said first door handle releasably engaging said cab for retaining said first door in a closed position;
a first keypad being coupled to said first door, said first keypad being electrically coupled to said first door handle, said first keypad facilitating said first door handle to be manipulated when a pre-determined code is correctly entered into said first keypad.

9. The assembly according to claim 8, further comprising a second door being hingedly coupled to said cab, said second door being aligned with said second doorway for opening and closing said second doorway.

10. The assembly according to claim 9, further comprising a second door window extending through said second door, said second door window being comprised of an ultraviolet blocking material.

11. The assembly according to claim 10, further comprising:
a second door handle being movably coupled to said second door, said second door handle releasably engaging said cab for retaining said second door in a closed position; and
a second keypad being coupled to said second door, said second keypad being electrically coupled to said second door handle, said second keypad facilitating said second door handle to be manipulated when a pre-determined code is correctly entered into said second keypad.

12. The assembly according to claim 11, further comprising a power supply being coupled to said cab, each of said headlights being electrically coupled to said power supply, each of said reverse lights being electrically coupled to said power supply, said first keypad being electrically coupled to said power supply, said second keypad being electrically coupled to said power supply, said air conditioning unit being electrically coupled to said power supply.

13. The assembly according to claim 12, wherein said power supply comprises:
a solar panel being coupled to said top wall of said cab such that said solar panel is exposed to sunlight;
an inverter being coupled to said cab, said inverter being electrically coupled to said solar panel for processing the electrical charge produced by said solar panel; and
at least one battery being coupled to said cab, said at least one battery being electrically coupled to said inverter such that said solar panel charges said at least one battery.

14. A tractor cab assembly being configured to protect a driver from sunlight while the tractor is being driven, said assembly comprising:
a cab being positionable on a tractor having said cab completely surround a driver's seat of the tractor, said cab have a plurality of window being integrated therein, each of said windows being comprised of an ultraviolet blocking material wherein said windows are configured to protect a driver of the tractor from ultraviolet radiation from the sun, said cab having a top wall and a perimeter wall extending downwardly therefrom, said perimeter wall having a distal edge with respect to said top wall defining an opening into said cab, said distal edge of said perimeter wall resting on a deck of the tractor having said top wall being spaced upwardly from the driver's seat, said outer wall having a front side, a back side, a first lateral side and a second lateral side, said first lateral side having a first doorway extending into an interior of said cab wherein said doorway is configured to facilitate the driver to enter and exit said cab, said second lateral side having a second doorway extending into an interior of said cab wherein said doorway is configured to facilitate the driver to enter and exit said cab said plurality of windows including a windshield and a set of rear windows, said windshield being positioned on said front side of said perimeter wall of said cab, each of said rear windows being positioned on said back side of said perimeter wall of said cab, each of said first lateral side, said second lateral side and said back side having mesh portions being integrated therein wherein said cab is configured to be ventilated, said mesh portion on said first lateral side extending between said first doorway and said back side, said mesh portion on said second lateral side extending between said second doorway and said back side, said mesh portion on said back side extending between said first lateral side and said second lateral side, said mesh portion on each of said first lateral side, said second lateral side and said back side extending downwardly from said top wall of said cab, each of said rear windows being positioned on said mesh portion on said back side, said set of rear windows including a left window, a middle window and a right window, said middle window tapering inwardly between a top edge and a bottom edge of said middle window such that said middle window has a trapezoidal shape, a top edge of each of said left window and said left window sloping downwardly;
a first door being hingedly coupled to said cab, said first door being aligned with said first doorway for opening and closing said first doorway;
a first door window extending through said first door, said first door window being comprised of an ultraviolet blocking material;
a first door handle being movably coupled to said first door, said first door handle releasably engaging said cab for retaining said first door in a closed position;
a first keypad being coupled to said first door, said first keypad being electrically coupled to said first door handle, said first keypad facilitating said first door handle to be manipulated when a pre-determined code is correctly entered into said first keypad;
a second door being hingedly coupled to said cab, said second door being aligned with said second doorway for opening and closing said second doorway;
a second door window extending through said second door, said second door window being comprised of an ultraviolet blocking material;
a second door handle being movably coupled to said second door, said second door handle releasably engaging said cab for retaining said second door in a closed position;
a second keypad being coupled to said second door, said second keypad being electrically coupled to said second door handle, said second keypad facilitating said second door handle to be manipulated when a pre-determined code is correctly entered into said second keypad;
a first rear view mirror being coupled to said first lateral side of said perimeter wall of said cab;
a second rear view mirror being coupled to said second lateral side of said perimeter wall of said cab;
a pair of headlights, each of said headlights being coupled to said cab wherein each of said headlights is configured to emit light outwardly therefrom, each of said headlights being positioned on said front side of said perimeter wall of said cab;
a pair of reverse lights, each of said reverse lights being coupled to said cab wherein each of said reverse lights is configured to emit light outwardly therefrom, each of said reverse lights being positioned on said back side of said perimeter wall of said cab;
an air conditioning unit being coupled to said cab, said air conditioning unit blowing air into said cab when said air conditioning unit is turned on, said air conditioning unit cooling the blown air when said air conditioning unit is turned on wherein said air conditioning unit is configured to cool the driver; and
a power supply being coupled to said cab, each of said headlights being electrically coupled to said power supply, each of said reverse lights being electrically coupled to said power supply, said first keypad being electrically coupled to said power supply, said second keypad being electrically coupled to said power supply, said air conditioning unit being electrically coupled to said power supply, said power supply comprising:
a solar panel being coupled to said top wall of said cab such that said solar panel is exposed to sunlight;
an inverter being coupled to said cab, said inverter being electrically coupled to said solar panel for processing the electrical charge produced by said solar panel; and
at least one battery being coupled to said cab, said at least one battery being electrically coupled to said inverter such that said solar panel charges said at least one battery.
